(19) United States
(12) Patent Application Publication
(10) Pub. No.: US 2008/0315007 A1
(43) Pub. Date: Dec. 25, 2008

(54) Grafitti Prevention System

(76) Inventor: Anthony George Bicknell, Havelock North (NZ)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/066,378

(22) PCT Filed: Sep. 8, 2006
(86) PCT No.: PCT/NZ2006/000233

§ 371 Date: Sep. 2, 2008

(30) Foreign Application Priority Data
Sep. 9, 2005 (NZ) 542313

(51) Int. Cl. B05B 1/00

(52) U.S. Cl. 239/67

(57) ABSTRACT

A graffiti prevention system for preventing application of graffiti to a surface(s). The system includes a control component (11) coupled to one or more modular components (21, 31). The control component (11) has a solenoid valve (12) which is coupled to a liquid supply. A motion sensor (19) upon sensing movement near surface(s) activates the solenoid valve (12) to cause liquid to flow from a pressure manifold (13) to spray pipes (14) so that liquid issues from spray nozzles (15, 16) onto the surface(s) to prevent graffiti from being applied to surface(s).

### BACKGROUND TO THE INVENTION

This invention relates to a graffiti prevention system, particularly a system that prevents a person from applying graffiti to a vertical surface.

There are many bare surfaces visible in populated areas, such as the sides of large buildings or other expansive structures, for example, over-bridges.

Unfortunately, some members of the public consider it necessary to “decorate” or deface these surfaces with unauthorised writing or drawing, whether artistic or otherwise. Portable cans of propellant spray paint are generally used by these persons, who are generally known as “taggers”.

Graffiti on buildings is damaging and unsightly. Also, graffiti is potentially very costly and time consuming for building owners and/or tenants to remove, as the graffiti must be cleaned off, and the surface made good to match the surrounding surface.

There are various passive means that have been developed to protect a buildings exterior surface from graffiti. One method is by the application of an anti-graffiti coating, which, when applied to a surface, prevents spray paint from adhering to the surface. Therefore, a building owner/person may more easily remove the graffiti from the surface.

It is unfortunate that taggers are very persistent, and in areas where graffiti is removed, it is quite likely that those areas will be targeted, and thus, the tagging will, most probably continue.

Thus traditional anti graffiti measures have a number of disadvantages. One disadvantage is that anti graffiti coatings are a passive measure, and they do not prevent a tagger from applying graffiti to the surface.

A second disadvantage is that building's surfaces to which an anti graffiti coating is applied, merely allows a building owner or tenant to remove the graffiti from the building surface in a less labour intensive, and less time consuming manner.

### SUMMARY OF THE INVENTION

It is an object of the present invention to provide an active graffiti prevention system that is associated with a vertical surface which may be a target for graffiti, but can be activated to prevent the application of graffiti to the surface.

Broadly according to one aspect of the invention there is provided a graffiti prevention system, made up of multiple component parts associated with a surface to which graffiti may be applied, the graffiti prevention system includes a motion sensing means, a controllable valve means for a liquid supply, the valve means being operable in response to the motion sensing means, a pressure manifold, the volume of which is at least equal to the volume of a spray conduit, and a plurality of nozzles coupled to the spray conduit.

Preferably, the system includes a cover to enclose components of the system.

### BRIEF DESCRIPTION OF THE INVENTION

In the following more detailed description of the invention according to preferred embodiments, reference will be made to the accompanying drawings in which:—

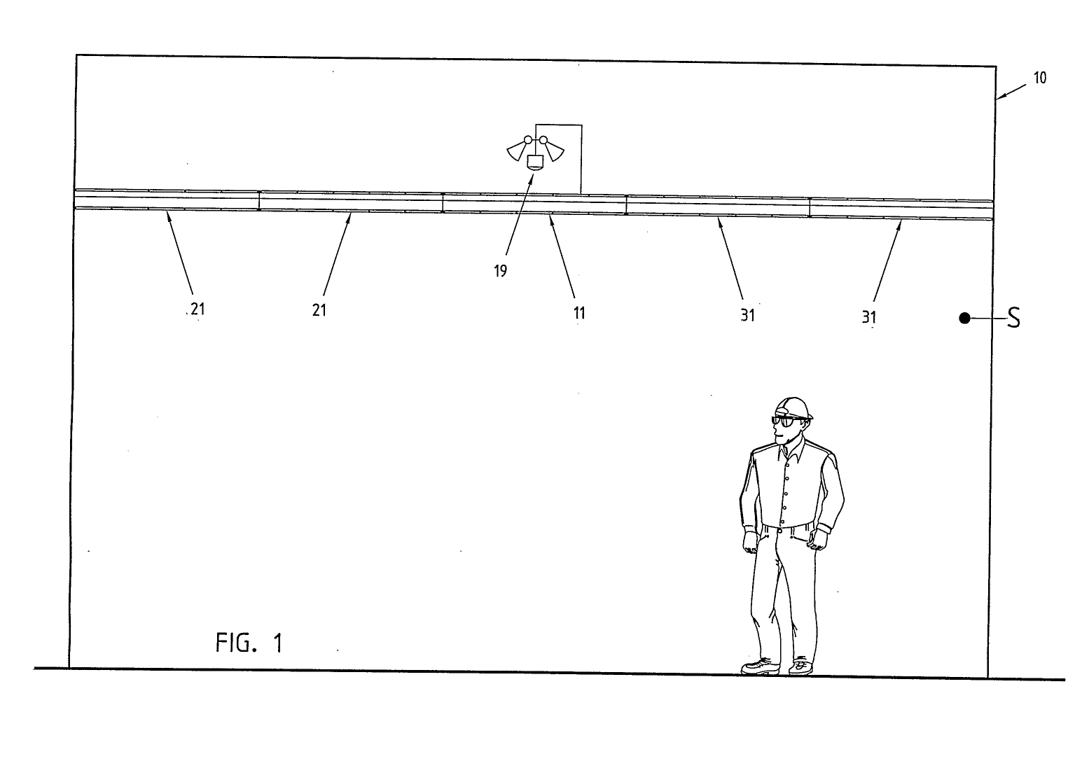

FIG. 1 is a front elevation of a vertical surface with which the graffiti prevention system of the present invention is associated,

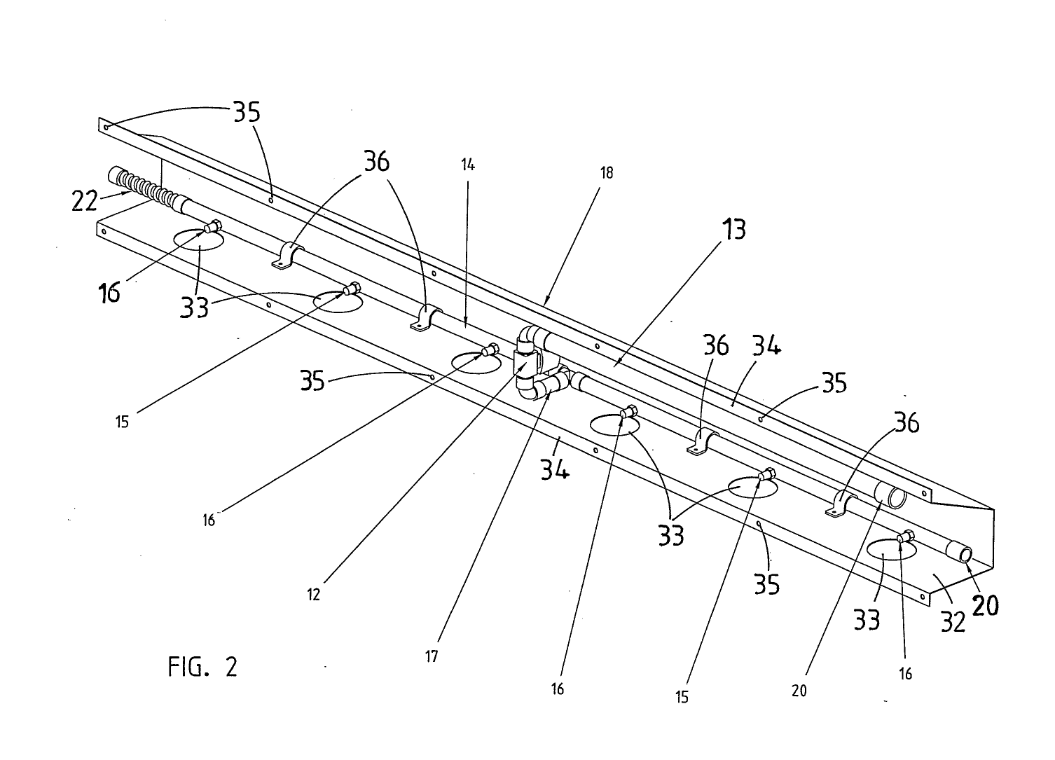

FIG. 2 is a perspective illustration of the control component of the graffiti prevention system,

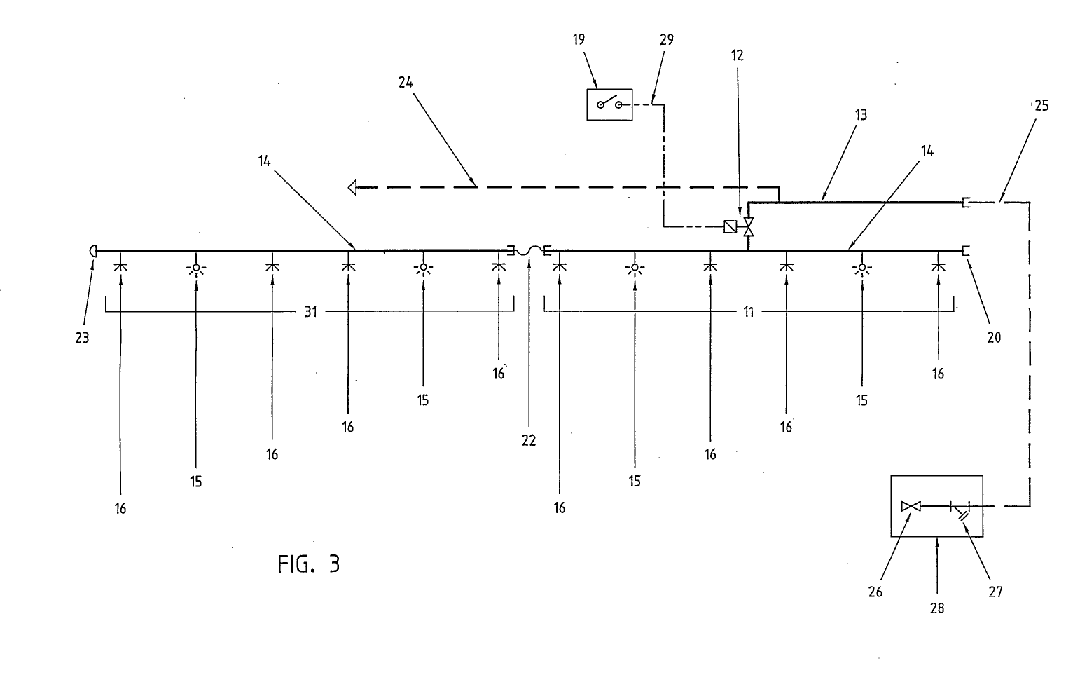

FIG. 3 is a schematic top plan view of the graffiti prevention system of FIG. 1 and incorporating the control component of FIG. 2 and showing the configuration of dispensing nozzles and associated equipment,

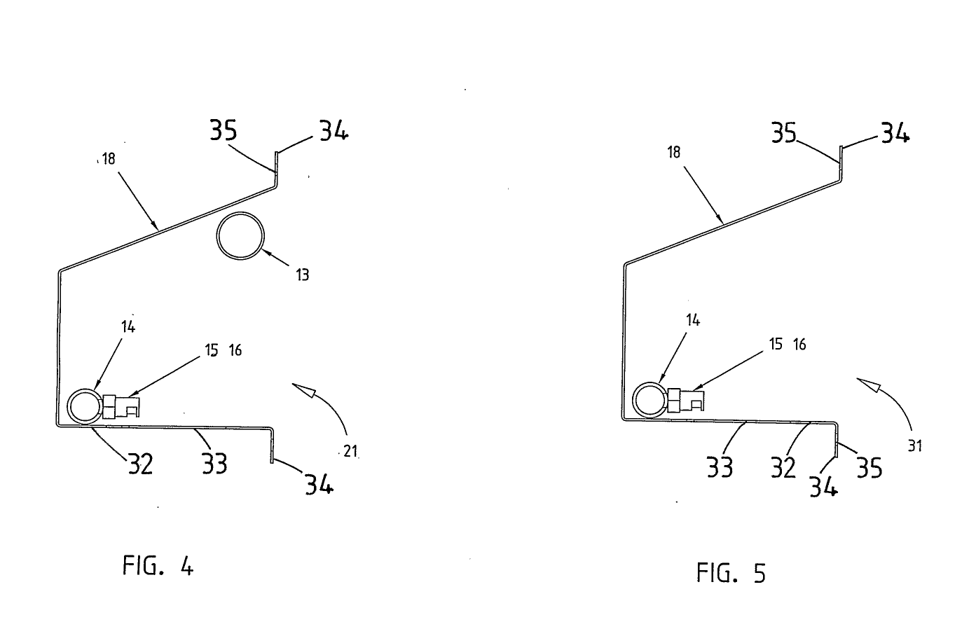

FIG. 4 is a cross section end elevation view through the control component of the graffiti prevention system of FIG. 2, and

FIG. 5 is a cross section end elevation view through a left side component (shown schematically in FIG. 3) of the graffiti prevention system of FIG. 1.

According to one embodiment of the invention there is provided a graffiti prevention system attachable to or adjacent a surface, the system being operative to prevent, or a least go some way to deterring a person from applying graffiti to the surface.

As is described herein, the graffiti prevention system is described as being attached to or associated with a vertical surface, where a water supply is located to one side (the left side) of the surface. The water supply couples to the system by way of a pressure manifold.

The graffiti prevention system 10, according to a preferred embodiment, is illustrated in the accompanying drawings. In one form of the invention, the graffiti prevention system 10 is of a modular construction and includes at least one modular control component 11. An example of the system is illustrated in FIG. 1.

Preferably, each component of the system is 2.4 meters long. However, it may be of any convenient length. As is described herein with reference to the accompanying drawings, the length of each component is illustrated to be 1.2 m long.

A central modular component 11 is provided which is illustrated in more detail in FIG. 2. This is the so-called control module 11. It contains a controllable valve means 12, such as a solenoid valve, a length of pressure manifold 13, and a length of spray pipe 14, to which are coupled a plurality of mist nozzles 15 and spray nozzles 16.

Preferably, the pressure manifold 13 is of 20 mm ID polybutene pipe, and couples to a mains water supply 25. However, this is only by way of example.

Preferably, the mains supply 25 (see FIG. 3) couples via an isolation valve 26. A filter 27 is preferably provided between the isolating valve 26 and the pressure manifold 13. Preferably, to prevent damage and unauthorised use of the isolation valve 26, a protective cover 28 encloses the filter 27 and isolation valve 26.

The pressure manifold 13 couples to the inlet side of the solenoid 12. Coupled to the outlet side of the solenoid 12 is a transfer pipe 17, the opposing end of which couples centrally to the spray pipe 14 via a suitable watertight connector, as illustrated in FIG. 2.

Preferably, the transfer pipe 17 and spray pipe 14 are of 15 mm ID polybutene pipe. Once again this is only by way of example.

Preferably, the sprinkler nozzles 15 and 16 are low cost devices. Thus in one embodiment they can be of a type commonly used in garden irrigation systems.

It will be apparent to the skilled addressee that there are many different types of sprinkler nozzles available which allow a user to select a desired spray pattern and water flow rate. As is disclosed herein, a first spray nozzle provides a fine spray, whilst a second spray nozzle is of a high flow, in order to drench the surface S.

The mist nozzles 15 and spray nozzles 16 can be coupled to the spray pipe 14, in the configuration as illustrated in FIG. 3.

A cover 18 encloses the inner workings of the graffiti prevention system. Preferably, the cover 18 is of a cross-sectional shape as illustrated in FIG. 4. As shown in FIG. 2 the cover 18 has a lower wall 32 with a series of openings 33 an opening being adjacent the outlet of each of the spray nozzles 15/16.

It will be apparent to the skilled addressee that the cover 18 may be made of any solid (robust) material, such as folded sheet-metal or a rigid plastic type material. The cover 18 may also be of any desired shape, and be of a size that covers the systems pipework and solenoid. Different shape designs could, for example, be employed to suit different building types.

The cover 18 preferably has a pair of flanges 34 (see FIG. 2) with apertures 35 such that the cover 18 can be fixedly mounted to a structure (e.g. the surface S).

The pressure manifold 13 and spray pipe 14, within component 11, are preferably coupled to an inside surface of the cover 18, as illustrated in FIG. 2. As shown, this mounting can be achieved by clips 36 straddling the spray pipe 14. The pressure manifold can be similarly mounted.

The system further includes one or more motion sensing devices. It will be apparent to the skilled addressee that there are many different types of motion sensing devices. As is disclosed herein, the, or each motion sensing device is a passive infrared sensor.

The motion sensing device can be mounted inside cover 18 to thereby lower the possibility of the sensor(s) being damaged by vandals.

It will be apparent to the skilled addressee that motion sensing device(s) may be connected with high intensity lamps, and timer means. The timer means determines the duration of time the lamps may operate, once the sensor has been triggered. As disclosed herein, a motion sensor including at least one high intensity lamp is described as being used.

An alarm (visual and/or audible) can also be connected into the system and operable upon the solenoid triggering. This can be fitted inside cover 18 for added protection.

The output from the motion sensing device 19 is electrically connected directly, or via a controller to the input of the solenoid 12. Thus, when the motion sensor 19 is activated, the solenoid 12 is activated to move from a first (closed) position to a second (open) position.

The motion sensor 19 is preferably attached adjacent the vertical surface S at a level which is unreachable by the general public. It should ideally be located at a position such that the motion sensor(s) coverage area equates to the size of the surface S and the immediate environs of the surface.

Where a surface is wider than a single sensor coverage area, more than one motion sensor 19 may be used.

A cross section through a right side modular component 21 of the graffiti prevention system of FIG. 1 is illustrated in FIG. 4. This module 21 contains a length of pressure manifold 13, and a length of spray pipe 14 with associated nozzles 15, 16.

Any number of right side components 21 may consecutively be coupled to the right side of the control component 11. However, it will be apparent to the skilled addressee that a system of this kind will have certain limitations in regard to water flow in long lengths of pipe.

Where a very wide graffiti prevention system is required, it may be advantageous to provide multiple smaller independent systems, located side by side, to protect a vertical surface S. Alternatively, an electric pressure pump can be used to achieve a desired pressure delivery. The pump would preferably be supplied by a reservoir tank controlled by say a ball cock valve, the tank being coupled to the “town” supply. The tank and pump can be mounted either inside or outside the building.

As an alternative, to multiple smaller independent systems connected together, it may be advantageous to include a continuation 24 (see FIG. 3) of the water supply pipe, so that mains pressure water may be supplied to subsequent pressure manifolds 13 (not illustrated in the drawings) placed further downstream. This thereby results in the pressure manifold 13 being filled with water over a pressure manifold length that would otherwise be impractical with only one water supply connection to the pressure manifold 13.

It will be apparent to the skilled addressee that there are many different methods of joining lengths of flexible pipe with the large number of connectors commercially available. For example, the connectors may be straight or flexible. As is disclosed herein and with reference to the accompanying drawings, a straight (rigid) connector 20 and/or a flexible connector 22 are described as being used (see FIG. 2).

Assuming the water supply is located at or toward the left side of surface S there will generally be one or more components 21 to the left of the central control unit 11. At the joint of each “right side component” 31, the pressure manifold 13 and spray pipe 14 therein will be coupled together end 31, to end by water tight connectors 20, as illustrated in FIG. 2.

The mist nozzles 15 and spray nozzles 16 are coupled to the spray pipe 14 within the right side component(s) 31, and arranged in the same manner as illustrated in FIG. 3.

To the right of the central unit 11 there will be one or more side components 31. These right side components 31 are of the same general construction as a right side component 21. However, the left side component 31 does not contain the pressure manifold 13. A cross section through a right side component 31 is illustrated in FIG. 5.

As described above, any number of left side components 31 may be consecutively coupled to the left side of the control component 11. The spray pipe 14 is joined together in adjacent components 31 by use of connectors as described above.

The joints between adjacent cover sections 18 may be sealed with a suitable weatherproof sealant, or be joined by mechanical fasteners. Generally the end of one cover 18 will overlap with the end of the next adjacent cover 18.

As assembled, the graffiti prevention system 10 may include at least one control component 11, but preferably, at least one right side component 21, and at least one left side component 31 will be coupled to the control component 11.

Preferably, the graffiti security system will be of a dimension equal to that of the width of the vertical surface S to be protected. This is the type of construction illustrated in FIG. 1.

The control component 11 will generally be located substantially centrally in relation to the width of the vertical surface S. As required, right side components 21 and left side components 31 are coupled end to end to the respective sides of control component 11.

The length of the left and/or right side components 31/21 may be cut to a shorter length to suit the width of vertical surface which is to be protected.

To the exposed ends of the left and right side components 31/21, end caps (not shown in the drawings) may be provided. End caps can fully enclose the pipe-work within the cover 18. These will preferably be fixed in place by use of suitable mechanical fasteners.

Also, the ends of the pressure manifold 13 and spray pipe 14 may be terminated by any suitable means. For example, the end of each respective pipe may be blocked by an end plug 23.

As illustrated in FIG. 1, at least one motion sensor 19 may be attached to or adjacent the vertical surface S. This is adjusted so that persons moving in close proximity to the protected portion of vertical surface S will be detected and give rise to activation of the sensor 19.

It can be appreciated that at certain times, it may be undesirable for the graffiti prevention system 10 to be operational, such as in times of high pedestrian flow past the protected surface. To accomplish this, a second timer means may be provided, connected in such a manner as to disable or enable the system as desired. Alternatively, a controller forming part of the system may have light sensing means to turn off the system during daylight periods.

In use, the graffiti prevention system 10 is attached to or adjacent the full width of a surface S to be protected, and located at a height above the reach of the general public.

When the graffiti prevention system 10 is operational, a tagger may approach the vertical surface S, having the intention to deface the surface with eg. a can of spray paint. When the tagger comes into range of the motion sensor 19, the motion sensor 19 activates.

Upon activation of the motion sensor, an electrical signal is sent from the motion sensor 19 to the water solenoid 12 (or a control unit coupled to solenoid 12) via electrical cable 29. Also, when the motion sensor 19 activates, the high intensity lamp, included with the motion sensor 19, illuminates the vertical surface S. This is a first deterrent to the tagger, as a tagger may be anxious about tagging a well lit surface.

Also, if an alarm is fitted this will activate and may deter the tagger.

The water solenoid 12 will open thereby allowing water to flow from the pressure manifold 13 into spray pipe 14.

The pressure manifold 13 is of a greater diameter than the spray pipe 14. Thus, as a large volume of water flows from the pressure manifold 13 into the spray pipe 14, the water pressure will, within the narrower diameter spray pipe 14, be higher than that within the pressure manifold 13. Therefore, water will be supplied relatively quickly to mist nozzles 15 and spray nozzles 16.

As the spray pipe 14 is quickly filled, water will thus flow out of each spray nozzle 16 coupled to the spray pipe, effectively drenching the vertical surface S with a stream of water. Water will also flow out of the mist nozzles 15. The mist will float down in close proximity to the vertical surface S.

It is intended that water from spray nozzles 16 will drench the vertical surface S before the tagger has reached surface S.

As the tagger is attempting to spray the surface S with the spray paint, the water droplets within the mist will interact with a stream of spray paint, resulting in the water mist diluting the stream of spray paint. Any spray paint that does contact the wet wall surface will not adhere to the surface, and will subsequently be washed away.

As paint will not adhere to a wet surface, the tagger can get no satisfaction in defacing the surface. Therefore, the tagger will, most probably, choose an “easier” target.

The motion sensor 19 may be adjusted so that it is more or less sensitive to movement. Also, a timer means may be included in the motion sensor 19 to allow setting of the duration of time the activated system may be allowed to operate for.

Once the desired operating time has elapsed, an electrical signal is sent from the timer means to the solenoid 12, thus deactivating the solenoid and shutting off the water supply.

The graffiti prevention system 10 is open to modification, as will be apparent to the skilled addressee.

According to another embodiment, a security camera may be included with the graffiti prevention system 10. The security camera, once activated by the motion sensor 19, may send images of the protected area to a central monitoring location, or to a remote storage means for later review.

According to yet another embodiment, a water meter may be fitted into the water supply pipe. Thus, an operator of the system may monitor the systems water usage. This is particularly useful for users who must pay for mains water reticulation.

According to another embodiment the mains pressure pipe may be enclosed by a protective cover.

The present invention provides a low cost and easily installed solution to prevent graffiti being applied to the vertical surface.

The system can be easily attached to a building, and is cost effective to operate.

To illustrate the effectiveness of the graffiti prevention system, a prototype version was installed onto the frontage of a shop. Prior to fitment of the system, graffiti was continually applied to the shop frontage. Once the graffiti prevention system was fitted to the shop frontage, the shop frontage has remained graffiti free.

An advantage of the system is that is may potentially enable a section of wall to remain clean and free from dirt.

A further use of the system is that it can work as an external fire retardant as the sensors will pick up the heat signature of any fire close to the building. This can cause the system to activate and keep the wall wet until the first signature has gone or the fire is put out.

1-20. (canceled)

21. A graffiti prevention system including a motion sensing means, a controllable valve for a liquid supply, the valve being operable in response to the motion sensing means, a supply line coupled to the valve and able to be coupled to a pressurised liquid supply, a spray conduit coupled to the valve and having a plurality of spray and mist producing nozzles coupled thereto.

22. The system as claimed in claim 21 wherein the supply line is of a greater diameter than that of the spray conduit.

23. The system as claimed in claim 22 wherein the supply line is of substantially 20 mm internal diameter and the spray conduit is of substantially 15 mm internal diameter.

24. The system as claimed in claim 23 wherein each of the supply line and spray conduit is formed of a flexible tubing.

25. The system as claimed in claim 24 wherein the flexible tubing is polybutene pipe.

26. The system as claimed in claim 21 wherein at least the spray conduit and valve are housed within a cover to form a control component, the cover having openings through which spray issuing from the nozzles can exit the cover.

27. The system as claimed in claim 26 wherein the cover includes mounting means to enable the cover to be fixedly mounted to a structure.

28. The system as claimed in claim 26 wherein the cover is formed from folded sheet metal or formed from a suitable plastics material.

29. The system as claimed in claim 26 wherein one or more modular components including a cover, spray conduit and spray nozzles are connected to the control component.

30. The system as claimed in claim 29 wherein one or more modular components are coupled to the modular components coupled to the control component.

31. The system as claimed in claim 29 wherein the spray conduits of adjacent components are coupled by way of straight or flexible connectors.

32. The system as claimed in claim 29 wherein the covers of adjacent control component and modular components are coupled together.

33. The system as claimed in claim 29 wherein one or more of the modular components include a supply line coupled together to the supply line of the control component.

34. The system as claimed in claim 21 wherein the spray nozzles are configured such that the spray nozzles wet a wall.

35. The system as claimed in claim 21 wherein the mist producing nozzles create a mist near a wall.

36. The system as claimed in claim 21 wherein the spray nozzles and the mist producing nozzles are interspersed along the spray conduit.

37. The system as claimed in claim 21 wherein the spray and mist producing nozzles are arranged in repeating groups with each group consisting of a mist producing nozzle located between a pair of spray nozzles.

38. The system as claimed in claim 21 further including one or more lights coupled to and activatable by the motion sensing means.

39. The system as claimed in claim 21 further including an alarm activatable by the motion sensing means.

40. The system as claimed in claim 21 including a camera activatable by the motion sensing means.
